(19) United States
(12) Patent Application Publication
(10) Pub. No.: US 2024/0308911 A1
(43) Pub. Date: Sep. 19, 2024

(54) CEMENTITIOUS COMPOSITION COMPRISING CARBONATED BIOCHAR

(71) Applicant: VICAT, L'isle-D'Abeau (FR)

(72) Inventors: Laury BARNES-DAVIN, Voiron (FR); François HUE, Bourgoin Jallieu (FR); Virginie NOWALSKI, Chassignieu (FR)

(73) Assignee: VICAT, L'isle-D'Abeau (FR)

(21) Appl. No.: 18/576,189

(22) PCT Filed: Jul. 7, 2022
(86) PCT No.: PCT/FR2022/051361

§ 371 Date: Jan. 3, 2024

(30) Foreign Application Priority Data
Jul. 8, 2021 (FR) FR2107418

(51) Int. Cl. C04B 20/02; C04B 18/10; C04B 28/02

(52) U.S. Cl. CPC C04B 20/023; C04B 18/101; C04B 28/02

(57) ABSTRACT

A cementitious composition including at least 5% of carbonated biochar and use of a carbonated biochar as the main constituent of a cementitious composition.

The subject of the present invention is new cementitious compositions with a low carbon balance containing carbonated biochar, as well as the use of carbonated biochar as the main constituent of a cementitious composition.

The manufacture of hydraulic binders, and in particular that of cements, essentially consists in calcining a mixture of carefully selected and dosed raw materials, also called «raw-mix». The cooking of this raw-mix gives an intermediate product, the clinker, which, milled with possible mineral additions, will give cement. The type of manufactured cement depends on the nature and proportions of the raw materials as well as the cooking method. There are several types of cements: Portland cements (which represent most of cements produced in the world), aluminous cements (or calcium aluminate), natural quick setting cements, sulfo-aluminous cements, sulfo-belitic cements and other intermediate varieties.

The most common cements are the Portland type cements. The Portland cements are obtained from Portland clinker, obtained after clinkering at a temperature in the range of 1450° C. from a raw-mix rich in calcium carbonate in a furnace. The production of one ton of Portland cement is accompanied by the emission of about 0.8 to 0.9 tons of CO₂.

Yet, in 2014, the amount of cement sold around the world was around 4.2 billion tons (source: French Trade Union for the Cement Industry-SFIC). This figure, which is constantly increasing, has more than doubled in 15 years. The cement industry is therefore today looking for a valid alternative to Portland cement, that is to say cements having at least the same strength and quality features as Portland cements. but which, during their production, emit less CO₂.

During the production of clinker, the main constituent of Portland cement, the release of CO₂ is linked to:
up to 40% for heating the cement kiln, in milling and in transport;
up to 60% of so-called chemical, or of decarbonation CO₂.

The decarbonation is a chemical reaction that takes place when limestone, the main raw material for making Portland cement, is heated at high temperature. The limestone is then transformed into quick lime and CO₂ according to the following chemical reaction:

CaCO₃→CaO+CO₂

The natural carbonation of cement-based materials, particularly concretes, is a potential way to reduce the carbon footprint linked to the manufacturing process and use of cement. However, although concrete prepared from these cements are naturally recarbonated during the life of the structures to the tune of 15% to 20% of the CO₂ emitted during manufacturing, the carbon balance associated with the production of Portland cement remains positive. It therefore remains necessary to reduce CO₂ emissions during the production of Portland cement and/or to improve end-of-life concrete recovery methods.

To reduce the CO₂ emissions related to the production of Portland cement, several approaches have been considered so far:
adapting or modernizing cement methods in order to maximize the efficiency of heat exchanges;
developing new «low carbon» binders such as sulfo-aluminous cements prepared from raw materials less rich in limestone and at a lower cooking temperature, which enables a reduction in CO₂ emissions of about 35%;
or even more (partial) substituting clinker in cements with materials allowing to limit CO₂ emissions.

Carbon capture and storage technologies have also been developed to limit CO₂ emissions from cement plants or coal-fired power plants. International patent application WO-A-2019/115722 describes a method allowing both the cleaning of CO₂-containing exhaust gases and the manufacture of additional cementitious material. The described method involves using recycled concrete fines comprising the provision of recycled concrete fines with d₉₀≤1000 μm into stocks or a silo as a starting material, rinsing the starting material to provide a carbonaceous material, the removal of the carbonaceous material and the cleaned exhaust gas, and the deagglomeration of the carbonaceous material to form the additional cementitious material, as well as the use of stocks or a silo containing a starting material of recycled concrete fines with d₉₀≤1000 μm for cleaning CO₂-containing exhaust gases and the simultaneous manufacture of an additional cementitious material.

However, this method is complex to implement and requires drying the carbonated product before it can be used.

To the date of the present invention, it remains necessary to identify new substitute materials making it possible to significantly reduce the CO₂ emissions during the production of cement while maintaining the mechanical properties of the construction materials prepared from these cements, in particular medium and long-term compressive strengths, at levels allowing their use.

The term «biochar» is the abbreviation of «bio-charcoal» in which the prefix «bio» denotes biological origin and «charcoal» corresponds to wood coal. Thus, «biochar» designates a charcoal of plant origin obtained by the pyrolysis of organic materials of various origins such as plants, in particular wood, straw and agricultural or green space residues, or organic compounds such as wastewater treatment plant sludge known as «STEP sludge».

The biochar differs from charcoal by its use as fertilizer rather than fuel and by its environmental impact, since it acts as a carbon sink (or CO₂ sink) rather than releasing CO₂ into the atmosphere during the combustion.

The biochar is therefore interesting for two reasons:
it concentrates a large amount of biogenic carbon (between 40 and more than 80%); and
its structure develops a large specific surface capable of adsorbing CO₂ in large amounts.

The biochar is thus classically used in agriculture to increase the quality of soils, and therefore their productivity. However, although the sequestration of carbon in the soil by burying biochar has been practiced for many years to combat their acidification and increase their fertility, losses and emissions of carbon in the form of CO₂ have been identified when the chemical balances of the soil (pH, leaching, burial depth, etc.) vary.

International patent application WO-A-2018/203829 describes the use of biochar as a substitute sand for the preparation of concrete or mortar type construction materials. However, this patent application does not describe the use of biochar as a cement additive

In the publication «The use of Biochar to reduce the carbon footprint of cement-based materials», Procedia Structural Integrity, 26 (2020), 199-210, authors Suarez-Riera et al. describe the use of biochar as a cement additive (or filler) with a view to reducing the carbon footprint of both cement production and the construction material prepared from it. According to the authors, the optimum substitution rate of cement by biochar is 2%, which remains relatively low.

In the publication «Use of biochar as carbon sequestering additive in cement mortar», Cement and Concrete Composition, 87 (2018), 110-129, authors Gupta et al. describe the use of biochar or carbonated biochar as an adjuvant (i.e. «admixture») for mortar. The biochar, carbonated or not, is added to mortar compositions in addition to other ingredients, including cement, but is not a substitute for the cement used to prepare the mortar. Moreover, the biochar, carbonated or not, is only added up to 2% by weight of the cement content. Finally, the authors conclude that the addition of non-carbonated biochar should be preferred to the addition of carbonated biochar, the resulting construction materials having significantly improved mechanical strength and permeability compared to obtained construction material following the addition of a previously carbonated biochar.

In another publication entitled «Carbon sequestration in cementitious matrix containing pyrogenic carbon from waste biomass: A comparison of external and internal carbonation approach», Journal of Building Engineering, 43 (2021), 1-20, the author Gupta studies the use biochar, carbonated or not, as an additive in cementitious compositions. In this publication, the author compares the mechanical properties of cementitious compositions containing 2.5% by weight of biochar, carbonated or not, with the mechanical properties of a composition consisting of 100% cement and a composition containing 8% silica fume. The author concludes that carbonated biochar could be used as an adjuvant («admixture»), which presupposes the use of small amounts of carbonated biochar in the cementitious composition.

Yet, it has now been found, quite surprisingly, that carbonated biochar could be used as the main constituent of a cementitious composition, which makes it possible to significantly increase the cement substitution rate compared to what was recommended until now, and therefore significantly reduce the carbon footprint of the construction material finally prepared while maintaining mechanical properties, and in particular medium and long-term compressive strengths compatible with the intended uses.

Thus, the subject of the present invention is a cementitious composition comprising at least 5% of carbonated biochar.

The addition of carbonated biochar in the compositions of the invention makes it possible to significantly increase the substitution rate of cement in comparison with biochar, and therefore to significantly lower the carbon footprint of the construction material finally prepared from said composition, while maintaining mechanical properties, and in particular medium and long-term compressive strengths compatible with the intended uses.

In the context of the present invention:
the term «adjuvant» (or «admixture») means any adjuvant for concrete, mortar or grout within the meaning of standard NF EN 934-2, that is to say any product incorporated at the time of mixing the concrete and mortar or grout at a dose less than or equal to 5% by weight of the cement content of the concrete in order to modify the properties of the mixture in the fresh and/or hardened state;
the term «biochar» means any material obtained by pyrolysis of biomass of organic materials of various origins such as plants, in particular wood, straw and agricultural or green space residues, or organic compounds such as sludge treatment plants known as «STEP sludge»;
the term «carbonated biochar» means any biochar which, after being brought into contact with a gas flow enriched in CO₂, retains part of it in its porous structure, and therefore contains adsorbed CO₂;
the term «aluminous cement» means any cement, amorphous or not, obtained by cooking a mixture of limestone and bauxite and containing at least 5% monocalcium aluminate CA;
the term «prompt natural cement» means any hydraulic binder with rapid setting and hardening conforming to standard NF P 15-314: 1993 in force on the date of the present invention. Preferably. «prompt natural cement» designates a cement prepared from a clinker comprising:
from 0% to 20% of C₃S;
from 40% to 60% of C₂S;
from 7% to 12% C₄AF;
from 2% to 10% C₃A;
from 10% to 15% of CaCO₃ (calcite);
from 10% to 15% of Ca₅(SiO₄)₂CO₃ (spurrite);
from 3% to 10% of sulfate phases: yeelimite C₄A₃$, langbeinite (K₂Mg₂(SO₄)₃, anhydrite (CaSO₄); and
from 10% to 20% lime, periclase, quartz and/or one or more amorphous phases;
the term «Portland cement» means any Portland clinker-based cement classified as CEM (I, II, III, IV or V) according to standard NF EN 197-1;
the term «sulfoaluminous cement» means any cement prepared from a sulfoaluminous clinker containing 5% to 90% of ‘yeelimite’ C₄A₃$ phase, a source of sulfate, and, optionally, a limestone addition;
the term «cementitious composition» means any cement-based composition or an alkali-activated binder capable of being used for the preparation of a construction material;
the term «main constituent of a cementitious composition» means any main constituent according to standard NF EN 197-1, that is to say any mineral material present in the cementitious composition in a proportion greater than 5% in weight of the cementitious composition; and
the term «construction material» means cement, concrete, mortar.

In the context of the present invention, the «adsorbed CO₂ rate» corresponds to the amount (% w/w) of adsorbed CO₂ contained in the carbonated biochar relative to the total weight of the carbonated biochar.

To determine the rate of adsorbed CO₂, different methods can be used such as for example a combination of calcination at different temperatures and an elemental carbon analysis making it possible to distinguish organic carbon, inorganic carbon and with certain devices to determine the carbon under other forms.

Using a BET analyzer can also determine the amount of CO₂ adsorbed in the porosity of the biochar. Finally, Raman and infrared spectroscopies are complementary techniques to the previous ones for detecting the adsorbed CO₂. Thus, to determine the rate of adsorbed CO₂, the following procedure can in particular be implemented:
place an alumina crucible on a balance and tare;
fill the crucible with the powder (biochar or cementitious material) to be analyzed by spreading it and weighing the test portion;
introduce the filled crucible into the CHS elemental analyzer;
enter the value of the sample mass;
note the total carbon content (CT) measured by the device;
then, to determine the inorganic carbon (CIT), start by calcining the powder (biochar or cementitious material) at 500° C. and then repeat the previous steps.

In the context of the present invention, the «total organic carbon» or «COT» corresponds to the amount (% w/w) of carbon which is not in inorganic form contained in an entity relative to the total weight of carbon contained in said entity. COT includes in particular carbon which is contained in organic compounds and the adsorbed CO₂.

The COT value of an entity is determined according to the following formula:

COT=CT-CIT
in which
   «CT» designates the amount (% w/w) of total carbon of the entity obtained through an elemental analysis with a carbon/sulphur (CS) analyzer on a raw sample; and
   «CIT» designates the amount (% w/w) of total inorganic carbon of the entity obtained by calcining the sample to be analyzed at 500° C. before carrying out a new determination of the elemental carbon by a CS analyzer.

In the context of the present invention, the median diameter or d₅₀ corresponds to the diameter below which is 50% of the total mass of the particles of the considered sample. This can be determined by any method known to those skilled in the art, in particular by dry or wet laser granulometry.

Finally, in the context of the present invention, the proportions expressed in % correspond to mass percentages relative to the total weight of the considered entity (e.g. clinker or cement).

The subject of the present invention is therefore a cementitious composition comprising at least 5% carbonated biochar. Preferably, the present invention relates to a cementitious composition as defined above having the following characteristics, chosen alone or in combination:
the composition comprises more than 5% of carbonated biochar; preferably the composition comprises at least 6% of carbonated biochar; more preferably the composition comprises at least 8% of carbonated biochar; very preferably the composition comprises at least 10% of carbonated biochar;
the composition comprises up to 30% of carbonated biochar; preferably the composition comprises up to 25% of carbonated biochar; very preferably the composition comprises up to 20% of carbonated biochar;
the carbonated biochar contains at least 1% adsorbed carbon; preferably the carbonated biochar contains at least 3% adsorbed carbon; more preferably the carbonated biochar contains at least 5% adsorbed carbon; very preferably, the carbonated biochar contains at least 7% adsorbed carbon;
the composition contains from 70% to 99% of cement or alkali-activated binder; preferably the composition contains from 75% to 98% of cement or alkali-activated binder; more preferably the composition still contains from 80% to 97% of cement or alkali-activated binder; very preferably the composition contains from 80% to 95% of cement or alkali-activated binder;
the composition contains an aluminous cement, a natural prompt cement, a Portland cement or a sulphoaluminous cement; and or
the composition further contains a filler or a cementitious addition according to standard EN 197-1.

The cementitious composition according to the present invention can be prepared according to any method known to those skilled in the art. By way of example, the composition according to the present invention can in particular be prepared by simple mixing in a mill or a mixer of a cement or an alkali-activated binder with the carbonated biochar or even by mixing in a mill or a mixer of a clinker, gypsum (and optionally limestone filler or any known additive) and carbonated biochar.

The cementitious composition according to the present invention is therefore obtained from a clinker, an alkali-activated binder or a cement and a carbonated biochar. The carbonated biochar can be obtained by any method known to those skilled in the art. By way of example, it can in particular cited a method for preparing carbonated biochar comprising the following steps:
introducing the biochar into a rotating drum, mixer, container or fluidized bed type reactor;
bringing the biochar into contact with a source of CO₂ such as exhaust gas from a cement plant or a thermal power plant; and
stopping gas injection and recovery of the obtained carbonated biochar.

The cementitious composition according to the present invention can be used to prepare a construction material.

Finally, the carbonated biochar described above can therefore be used as the main constituent of a cementitious composition. Thus, the present invention also relates to the use of a carbonated biochar as the main constituent of a cementitious composition.

The present invention can be illustrated in a non-limiting manner by the following examples.

### EXAMPLE 1—CARBONATED BIOCHAR

A carbonated biochar is obtained by placing approximately 500 g of biochar obtained by pyrolysis of wood in a tank which is itself placed in a hermetically closed glass reactor.

The reactor is equipped with a cup containing water to regulate the relative humidity in the reactor.

This cup is placed at the bottom of the reactor under the tank containing the biochar.

The reactor cover is equipped with a glass stopper pierced with 2 orifices which allow the injection of a gas and its evacuation.

The gas injected for 65 hours consists of 100% CO₂.

The biochar thus carbonated has the following characteristics (Table 1).

TABLE 1
Biochar/carbonated biochar

| | Biochar (before | |
|---|---|---|
| | introduction into the | Carbonated |
| | reactor) | biochar |
| Mass (in g) | 501.6 | 502.5 |
| COT (%) | 77.02 | 84.7 |

### EXAMPLE 2—CEMENTITIOUS COMPOSITIONS ACCORDING TO THE INVENTION

A reference Portland cement of class CEM I 52.5 R is mixed with different amounts of powder from the carbonated biochar obtained in Example 1 or with the powder from the non-carbonated biochar used in Example 1.

The biochar powder is obtained by milling a biochar of which all particles are less than 2 mm and the d₅₀ is 43 μm. Once milled in a ring mill, the biochar has a d₅₀ of 11 μm.

The composition of cementitious compositions 2 and 4 (compositions according to the invention) and 3 and 5 (cementitious compositions prepared from a non-carbonated biochar) thus obtained is reported in Table 2 below.

TABLE 2
Cementitious compositions 1 to 5

| | Cementitious composition | | | | |
|---|---|---|---|---|---|
| | 1 | | | | |
| | (Reference) | 2 | 3 | 4 | 5 |
| CEM \| 52.5 | 100 | 95 | 95 | 90 | 90 |
| (% w/w) | | | | | |
| Carbonated | 0 | 5 | 0 | 10 | 0 |
| biochar | | | | | |
| (% w/w) | | | | | |
| Biochar | 0 | 0 | 5 | 0 | 10 |
| (% w/w) | | | | | |
| COT (%) | 0.23 | 3.57 | 3.38 | 7.76 | 7.41 |

The gain in CO₂ emissions for the cementitious compositions 2 to 5 compared to the reference cementitious composition 1 is reported in Table 3 below.

TABLE 3
CO₂ gain for cementitious compositions 2 to 5

| | Cementitious composition | | | |
|---|---|---|---|---|
| | 2 | 3 | 4 | 5 |
| CO₂ gain compared | 207 | 205 | 385 | 382 |
| to the reference | | | | |
| (KgCO₂ eq/t) | | | | |

### EXAMPLE 3—MECHANICAL PERFORMANCES

The compressive strength of the cementitious compositions 1, 2, 4 and 5 obtained in Example 2 was measured on prismatic specimens of standardized mortar (4×4×16 cm³), at different time periods (1, 2, 7 and 28 days) according to the standard EN 196-1.

The results obtained are reported in the following Table 4.

TABLE 4
Compressive strengths of cementitious
compositions 1, 2, 4 and 5

| | Cementitious composition | | | |
|---|---|---|---|---|
| | 1 | 2 | 4 | 5 |
| R_{c} (in MPa) | 29.3 | 25 | 23.3 | 22.1 |
| at 1 day | | | | |
| R_{c} (in MPa) | 41.7 | 35.3 | 35.1 | 31.7 |
| at 2 days | | | | |
| R_{c} (in MPa) | 52.9 | 47.1 | 48.7 | 43.7 |
| at 7 days | | | | |
| R_{c} (in MPa) | 61.6 | 58 | 56.8 | 54 |
| at 28 days | | | | |

The cementitious compositions according to the invention (i.e. 2 and 4) present acceptable performances with regard to those observed for the reference CEM I at all deadlines.

However, it is noted a reduction in the mechanical performances of the composition 5 containing 10% of non-carbonated biochar while for the composition 4 containing carbonated biochar in the same proportions, it is noted a maintenance of mechanical performances in the short, medium and long term at an acceptable level. The addition of 10% of carbonated biochar therefore makes it possible to maintain a level of resistance higher than that observed for the composition containing the same amount of non-carbonated biochar.

1. A cementitious composition comprising at least 5% of carbonated biochar.

2. The cementitious composition according to claim 1, wherein it comprises more than 5% of carbonated biochar.

3. The cementitious composition according to claim 2, wherein it comprises at least 8% of carbonated biochar.

4. The cementitious composition according to claim 3, wherein it comprises at least 10% of carbonated biochar.

5. The cementitious composition according to claim 1, wherein comprises up to 30% of carbonated biochar.

6. The cementitious composition according to claim 5, wherein it comprises up to 25% of carbonated biochar.

7. The cementitious composition according to claim 1, wherein the carbonated biochar contains at least 1% adsorbed carbon.

8. The cementitious composition according to claim 1, wherein it contains from 70% to 99% of cement or alkali-activated binder.

9. The cementitious composition according to claim 1, wherein it contains an aluminous cement, a prompt natural cement, a Portland cement or a sulfoaluminous cement.

10. A method comprising obtaining a cementitious composition with a carbonated biochar as the main constituent.
